(19) United States
(12) Patent Application Publication
(10) Pub. No.: US 2012/0222476 A1
(43) Pub. Date: Sep. 6, 2012

(54) PLASTIC ROLLER FOR A MOTOR VEHICLE BRAKE TEST BENCH AND SUCH A BRAKE TEST BENCH

(75) Inventor: Klaus Kirstätter, Wetzlar (DE)

(73) Assignee: SNAP-ON EQUIPMENT SRL A UNICO SOCIO, Correggio (IT)

(21) Appl. No.: 13/388,877

(22) PCT Filed: Aug. 4, 2010
(86) PCT No.: PCT/EP2010/004789

§ 371 Date: May 21, 2012

(30) Foreign Application Priority Data
Aug. 4, 2009 (DE) 10 2009 036 009.3

(51) Int. Cl. G01L 5/28

(52) U.S. Cl. 73/123

(57) ABSTRACT

The invention concerns a roller for a motor vehicle brake test bench comprising a roller body (11), wherein the peripheral wall (17) of the roller body (11) is formed at least partially from plastic. The invention further concerns a brake test bench (12) for motor vehicles having such a roller (10).

The invention concerns a roller for a motor vehicle brake test bench and such a brake test bench. In particular the invention concerns a roller comprising a roller body and a brake test bench which has a rolling device for rolling the wheels of the motor vehicle with at least one rotatably mounted roller, a drive unit for driving and decelerating the rolling device and a control unit for controlling the drive unit.

In practice brake test benches are used for example to carry out brake testing operations on vehicles such as for example passenger cars and trucks as well as motorcycles. In such test benches the wheels of the driven axle of the vehicle to be tested are placed on one or more rotatably mounted rollers. Various test cycles are then implemented, in which the braking performance can be tested.

A brake test bench is known for example from WO 2008/034629 A1. In that vehicle brake arrangement the wheel to be tested is in contact with two driven rollers. Those two rollers serve to test the brakes.

In that case the rollers used in the state of the art are made from steel and have a hollow profile. A disadvantage with such steel rollers are the high production costs and their high weight. The latter is found to be a disadvantage in particular in regard to the final mounting procedure or maintenance operations.

Therefore the object of the present invention is to provide a roller for a motor vehicle brake test bench which makes it possible to carry out as many testing operations on a vehicle as possible, at the lowest possible cost. A further object of the invention is to provide a brake test bench having such a roller.

The foregoing object is attained in respect of the roller by the features of claim 1. Further advantageous configurations of the roller according to the invention are recited in claims 2 to 9. In addition the foregoing object is attained in regard to the brake test bench by the features of claim 10.

In particular there is provided a roller for a motor vehicle brake test bench comprising a roller body, wherein the peripheral wall of the roller body is at least partially made of plastic, wherein the roller body can be either a hollow cylinder or a solid profile. A roller made from plastic is very wear-resistant. In addition such a roller is of a substantially lower weight than a steel roller, which has an advantageous effect on the mounting assembly for the roller. In addition rollers of plastic are desirable in terms of manufacture because of the low raw material price. In addition plastic rollers can be produced in high numbers and in a reproducible quality, and manufacture can be easily automated.

In an advantageous configuration the peripheral wall of the roller body is formed completely from plastic. The roller is either a circular-cylindrical hollow body or a circular-cylindrical solid profile, wherein the entire peripheral wall of the roller body is formed from plastic, that is to say a profiling which is possibly provided is also formed from plastic.

Preferably the roller body has a profiled surface. The profiling reduces the possibility of the occurrence of slippage. So-called slippage can occur if there is a low level of adhesion between the tyre and the roller and can inadmissibly falsify the measurement results.

The profiled surface can be formed by depressions arranged in the surface of the roller body.

In addition or alternatively the profiled surface could also be formed by raised portions arranged on the surface of the roller body.

The shape of the profiled surface can vary. The depressions and/or raised portions can be in point or line form. The depressions and/or raised portions are for example of a pyramid shape, wherein the pyramid has a rhombus in particular as the base surface, wherein in particular the tip of the pyramid is above the point of intersection of the diagonals of the rhombus.

In a configuration in point form, that is to say with a plurality of depressions and/or raised portions which are in point form, those depressions and/or raised portions can be for example of a semicircular cross-section to optimise adhesion under different conditions of use.

In addition the profiled surface can have any suitable pattern. For example the profiling can extend in the shape of a helical line. The helical configuration prevents the formation of regions extending in a ring around the roller, without profiling, being regions on which then in particular tyres with spikes would not enjoy any adhesion.

It can also be provided that a plurality of helical line portions are provided on the surface of the at least one roller, which extend in opposite relationship and/or involve different gradients. That arrangement of the profiling provides for optimum adhesion between tyre and roller as the tyre is in engagement with a minimum area of the roller at any time.

In an embodiment the depressions are milled into the surface of the roller body. Accordingly the roller is made from plastic and then the depressions are milled therein in a second working step. Advantageously in that way rollers without profiling can be manufactured in an automated procedure in large numbers and it is only then that each individual roller can be individually adapted to the given required condition of use.

Preferably in addition or alternatively the raised portions can be injected onto the surface of the roller body. Accordingly the roller is made from plastic and then the raised portions are injected thereon in a second working step.

The depressions and/or raised portions are preferably arranged distributed uniformly on the surface.

The roller body can be produced by injection moulding. In the injection moulding procedure the moulding material is melted in a cylinder and then the molten material is injected under high pressure into a steel mould. After cooling the plastic component is removed from the steel mould. In that case the steel mould can be provided with raised portions and/or depressions so that it is possible to dispense with subsequent milling or injection.

Alternatively the roller body can be produced by pressing. In that case the pressing material becomes plastic under the action of pressure and/or heat and in that case fills up the tool cavity. This therefore involves thermal shaping in a mould under pressure or also without pressure. In that case the mould can be provided with raised portions and/or depressions so that it is possible to dispense with subsequent milling or injection.

The invention further concerns a brake test bench for motor vehicles comprising a rolling device for rolling the wheels of the motor vehicle having at least one rotatably mounted roller, a drive unit for driving and decelerating the rolling device, and a control unit for controlling the drive unit and a roller of the aforementioned kind. In regard to the advantages attention is directed to the foregoing description.

Further features and advantages will be apparent from the description hereinafter and the drawings. The invention is described by means of an embodiment. In the drawings:

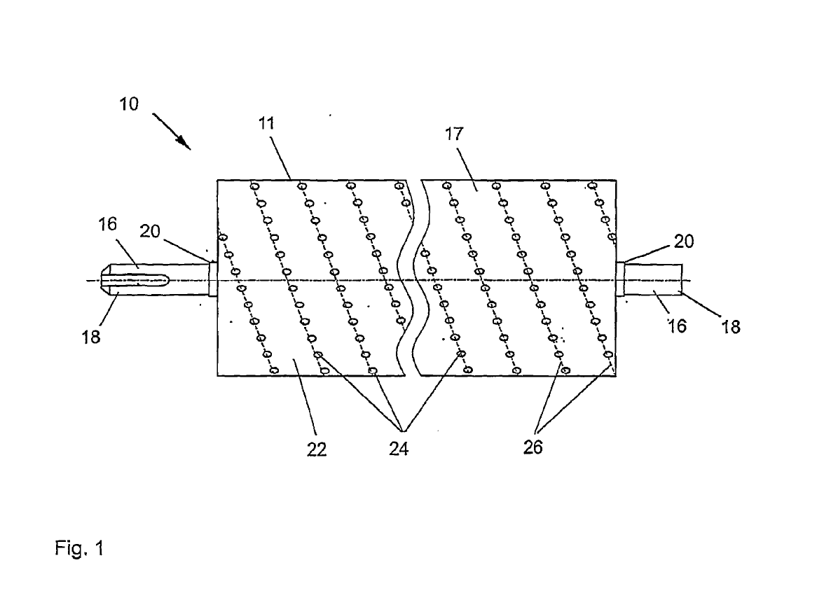

FIG. 1 shows a plan view of a roller according to the invention, and

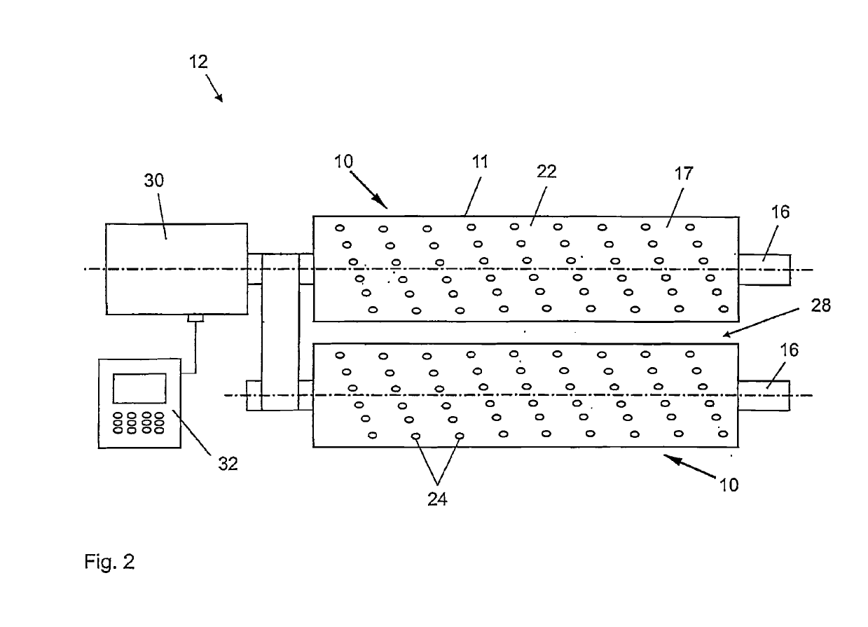

FIG. 2 shows a plan view of a brake test bench according to the invention with two rollers as shown in FIG. 1.

FIG. 1 shows a roller 10 according to the invention which can be fitted in a brake test bench 12 according to the invention (see FIG. 2).

The roller 10 has a circular-cylindrical roller body 11 which is either in the form of a solid profile or a hollow body. A shaft 16 projects with its ends 18 out of the roller body 11. The ends 18 have a portion of a smaller diameter, whereby there is formed a respective shoulder 20 which serves for mounting the shaft 16 and thus the roller 10. The shaft 16 is preferably a steel shaft which is suitably connected in play-free manner to the roller body 11 so that a non-rotatable connection is made between the roller body 11 and the shaft 16.

The peripheral wall 17 of the roller body 11 is formed at least partially from plastic, wherein the nature and/or wall thickness (in the configuration in the form of a hollow profile) of the plastic used are so selected that it does not suffer deformation under the loading of a vehicle to be tested. The polymer used enjoys in particular notch impact toughness. The plastic used belongs to the thermoplastic materials.

In the illustrated embodiment the peripheral wall 17 of the roller body 11 is formed completely from plastic, the plastic being produced by injection moulding.

Depressions 24 are arranged in the surface 22 of the roller body 11. They can either already be produced in manufacture of the roller 10 or they can be subsequently milled into the surface 22.

The depressions 24 shown in FIGS. 1 and 2 are of a semicircular cross-section, the depressions 24 being arranged in the surface 22 of the roller body 11 along a helical line 26 (see FIG. 1).

It would equally well be possible to provide raised portions (not shown) on the surface 22 of the roller body 11. Those raised portions are for example injected onto the roller body 11.

FIG. 2 shows the roller test bench 12 according to the invention with the two substantially horizontally extending rollers 10. The rollers 10 are oriented in axis-parallel relationship with each other in such a way that a uniformly wide gap 28 is formed between them. The rollers 10 are mounted in a frame structure (not shown) which also carries the bearing units (also not shown).

A drive unit 30 oriented coaxially with one of the rollers 10 in the form of a motor drives the rollers 10. Connected to the motor is a control unit 32 in which various test programs are stored. In accordance with the vehicle to be tested and/or the test operation to be performed, a desired program is called up, which then controls the drive unit 30 for driving or decelerating the rollers 10.

In operation a vehicle is placed with its driven axle on the two rollers 10. The rollers 10 are caused to rotate by the motor which is controlled by the corresponding control unit 32 by a preselected program. The wheel of the vehicle, which in that case also rotates therewith, is braked by the brake of the vehicle. It is possible to infer the condition of the brake from the resistance which the brake of the vehicle opposes to the drive by the roller.

1. A roller for a motor vehicle brake test bench comprising a roller body (11),
characterised in that the peripheral wall (17) of the roller body (11) is formed at least partially from plastic.

2. A roller according to claim 1,
characterised in that the peripheral wall (17) of the roller body (11) is formed completely from plastic.

3. A roller according to claim 1 or 2,
characterised in that the roller body (11) has a profiled surface (22).

4. A roller according to claim 3,
characterised in that the profiled surface (22) is formed by depressions (24) arranged in the surface (22) of the roller body (11).

5. A roller according to claim 4,
characterised in that the depressions (24) are milled into the surface (22) of the roller body (11).

6. A roller according to one of claims 3 to 5,
characterised in that the profiled surface (22) is formed by raised portions arranged on the surface (22) of the roller body (11).

7. A roller according to claim 6,
characterised in that the raised portions are injected onto the surface (22) of the roller body (11).

8. A roller according to one of claims 4 to 7,
characterised in that the depressions and/or raised portions are arranged distributed uniformly on the surface (22).

9. A roller according to one of the preceding claims,
characterised in that the roller body (11) is produced by injection moulding.

10. A brake test bench for motor vehicles comprising
a rolling device for rolling the wheels of the motor vehicle having at least one rotatably mounted roller (10),
a drive unit (30) for driving and decelerating the rolling device, and
a control means (32) for controlling the drive unit (30),
characterised in that
there is provided a roller (10) according to one of claims 1 to 9.
